(19) United States
(12) Patent Application Publication
(10) Pub. No.: US 2008/0244438 A1
(43) Pub. Date: Oct. 2, 2008

(54) SYSTEM AND METHOD FOR DISPLAYING CONTENT BY MONITORING USER-GENERATED ACTIVITY

(76) Inventors: Keith Peters, San Francisco, CA (US); Richard Skrenta, San Carlos, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/864,859

(22) Filed: Sep. 28, 2007

Related U.S. Application Data
(60) Provisional application No. 60/909,441, filed on Mar. 31, 2007.

(51) Int. Cl. G06F 3/00

(52) U.S. Cl. 715/772

(57) ABSTRACT

In an online environment, specific threads or forums of user-generated posts are selected for prominence based on some detected measure of user-activity in that thread and/or forum. The select threads or forums may be identified by measuring or quantifying the amount of interactive content provided in such threads or forums. Based on the determinations, embodiments provide that information or links are displayed in prominence on the online site, where the information or links direct viewers to locations of select threads.

### RELATED APPLICATION(S)

This application claims benefit of priority to Provisional U.S. Patent Application No. 60/909,441, entitled “Ranking and Displaying Interactive Content”, filed on Mar. 31, 2007. The aforementioned priority application is hereby incorporated by reference in its entirety.

### TECHNICAL FIELD

The disclosed embodiments relate generally to the field of user-generated network content.

### BACKGROUND

Interactive content is an increasingly large part of the online information medium. Such content often takes the form of comment postings, recommendations or rankings. The use of interactive content is a point of focus in drawing audience and viewers to a particular webpage or site.

### BRIEF DESCRIPTION OF THE DRAWINGS

FIG. 1 illustrates a method for inserting a user-defined post on a forum and/or network.

FIG. 2 illustrates a method for ranking and displaying a forum and/or other content items on an associated network.

FIG. 3 illustrates a system for enabling a ranking and displaying of a forum on an associated network.

FIG. 4 is a screenshot of a thread provided under an embodiment of the invention.

FIG. 5 is a screenshot of a main page of prominence, under another embodiment of the invention.

### DETAILED DESCRIPTION

Overview

One or more embodiments provide a website that is configured to place in prominence information or links to select threads, forums or other mediums of user-generated content and activity. In one embodiment, specific threads or forums of user-generated posts (e.g. comments or messages) are selected for prominence based on some detected measure of user-activity (e.g. most popular or most increase in user-activity) in that thread and/or forum. The select threads or forums may be identified by measuring or quantifying the amount of interactive content provided in such threads or forums. Based on the determinations, embodiments provide that information or links are displayed in prominence on the online site, where the information or links direct viewers to locations of select threads. As an alternative or addition, information or links may be displayed in prominence to link viewers to select forums.

According to an embodiment, a site may operate individual threads that relate to a particular subject, category and/or content item. Under one embodiment, threads are provided in association with a specific article, such as a news story or other content item. The threads may be provided on a page that links to the associated article and/or displays content from or based on the associated article. Each thread may contain one or more postings that relate to the content item and/or to other postings in the thread. According to an embodiment, a site may operate numerous threads (e.g. hundreds or more), and the site may provide links or other information at various internal locations that direct site visitors to a specific thread. The specific thread may be selected at a given interval based on a measurement of activity of that selected thread (or the forum containing the thread) in that interval of time. When threads relate to a specific article or news story, for example, the prominence of that thread enables the site operator to provide quick links to a story that is drawing a high-level of interest. At the same time, the site operator is able to inform its general audience of the particular news story (or other content item) that is of interest in a given time interval.

In another embodiment, user-postings may also be aggregated into forums, which may include multiple threads. Forums may be identified by category or subject or other classification. As an alternative or addition to placing links or information about threads in prominence, one or more embodiments may provide links or identification of forums that are of interest in a given interval. Such forums may be selected for such prominence based on a measurement of user-activity in the forums.

In one implementation, threads may be enabled independently or without a forum. For example, a thread may not have a forum, or it may be listed with two or more forums. As an alternative or variation, threads and/or forums may be associated with a category or topic classification. In one implementation, a site may assign pages to categories, such as categories of current events. The content on that page may then pertain to the assigned category or topic. Threads may be provided on individual pages by enabling site visitors to add comments or postings to articles, documents and other content items that are provided or made available at the page. At the same time, a site may provide a forum that links threads from multiple articles or documents that appear or are assigned to the category of the page.

Under one embodiment, the articles, documents and content items that are provided at a site may individually have multiple category, topic or classification assignments. As such, one news story, for example, may have more than one category assignment and thus appear on more than one page simultaneously. A content item with multiple category assignments may be associated with a thread. The thread may be associated with the forum of each category that the content item is assigned to. Thus, one thread may be provided in multiple forums, and an individual forum may link or combine threads provided with content items that only partially share a common category.

Embodiments also contemplate category assignments that are of a genus or species type. In such cases, one content item may have a particular general classification (e.g. “Baseball”) and a more detailed classification (“Giants”). A thread for the forum of a sub-topic (e.g. “Giants”) may be shared or used by the forum of the classification (“Baseball”). In each scenario for how threads and forums may be used, one or more embodiments contemplate use of quick links or listings on the site that enable the user to navigate quickly, or at least view and identify, select threads or forums that are deemed by the site operator to be of significant user-interest.

By placing links or information about threads and/or forums that have significant user activity, a website may direct its audience to locations within the site that are of current interest to viewers. For example, on a news site, the thread with the greatest number of posts (or increased number of posts) may reflect the news item of the day that has the greatest level of interest. The prominence may be provided by a link (i.e. quick link) to the news item, and/or to its thread. Alternatively, the link may be provided to a page where the link to the news item and/or the thread or related forum or provided. The quick link may be provided on, for example, a main page of the site for purpose, so as to serve the purpose of enabling the audience to locate and participate in the content about the news story of current interest.

Still further, the threads, forums and other mediums of user-generated activity may be used to detect topics of interest to the general audience of the website. Identified topics of interest may be emphasized, or treated with more prominence on the website.

The term “user-generated”, as in the context of “user-generated content”, generally refers to users of the audience of a website as a class. Thus, for a web page that is viewed by thousands in a given time period, the user-generated content may refer to forums or other mediums in which some persons in the audience provide postings or submit other content. A “user-generated content medium” refers to a web medium, such as a forum or thread, where content (e.g. postings) are provided from users of the site as a class. A user-generated content medium may include a forum or a thread.

As used herein, a posting refers to data (e.g. text, image, link) uploaded by a user to a location on a site. A thread is a chain of postings that either relate to one another or to a common underlying content item. A forum may be an identification of threads, or of postings that are not part of a chain that stem or append from a document (e.g. news story) or other content.

Embodiments described herein also include a system for providing content on a website. A system may include a content manager, a user-generated content medium manager, an analyzer of the user-generated content medium manager, and a presentation component. The content manager is configured to generate data for a plurality of category-specific presentations, where each category-specific presentation includes content based on a plurality of content items that have been programmatically or manually determined to be pertinent to a category of that presentation. The user-generated content medium manager is configured to manage, for each category-specific presentation, one or more user-generated content mediums. Each of the one or more user-generated content mediums receives and displays postings from users of the website. The analyzer monitors an activity level of each of the one or more user-generated content mediums on the website in order to select one or more user-generated content mediums for prominence. The presentation component that is configured (i) to receive the data from the content manger to provide the plurality of category-specific presentations, (ii) to communicate with the manager in enabling use and presentation of the one or more user-generated content mediums, (iii) to identify, from the analyzer, the selected one or more user-generated content mediums, and (iv) present the selected one or more user-generated content mediums in prominence on the website.

One or more embodiments described herein may be implemented through the use of modules or software/logic components. A module refers to a program, a subroutine, a portion of a program, a software component, firmware or a hardware component capable of performing a stated task or function. A module can exist on a hardware component such as a server independently of other modules, or a module can exist with other modules on the same server or client terminal, or within the same program. A module may be implemented on a client or on a server, or distributed between clients, servers, or amongst a client-server.

Furthermore, one or more embodiments described herein may be implemented through the use of instructions that are executable by one or more processors. These instructions may be carried on a computer-readable medium. Services and components illustrated by figures in this application provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and PDAs), and magnetic memory. A computer-readable medium as used herein may extend across multiple machines. For example, the medium may be distributed between client and server in order to perform a stated task or operation.

Methodology

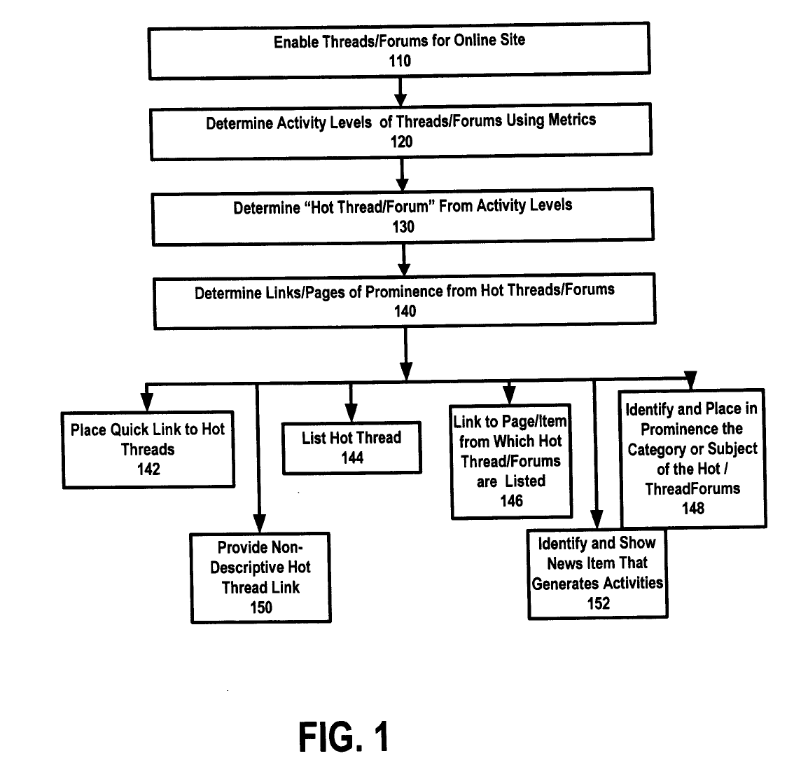

FIG. 1 illustrates a method for employing user-generated content to direct an audience to a particular location within a site, under an embodiment. A method such as described may be performed on a server or other computers on which threads and/or forums and other online content may be hosted. In one embodiment, a method such as described with FIG. 1 is provided on a site where content items in the form of stories, news events, message boards, blogs and other content is aggregated. In one implementation, the aggregation of the content items may correspond to the compilation of links to content items, with or without text abstracted or summarized from such content items. Content may be aggregated on individual pages or presentations provided from a site. For example, the site may provide numerous pages, each of which aggregate and display content pertaining to a particular topic or category.

In a step 110, threads and/or forums (or other mediums of user-generated content) are enabled for the online site. The threads or forums may accept postings from users in various forms. Postings may be in the form of comments that accompany a story or news item, or which are posted to a category or other topic provided on a given page within the site. The postings may be rendered from displayed links, or alternatively in an opened format. When opened, at least some of the text from individual posts are presented with or without links, and are viewable without further link selections. Threads may be generated by enabling users to post replies to other posts. For example, reply threads are posted together in one sub-thread. Numerous other alternatives are possible.

Step 120 provides that the activity levels of different threads and/or forums is determined based on anyone of many metrics. The metrics may include, for example, one or more of the following: (i) total number of postings in one interval, (ii) number of postings in one interval, as compared to a previous interval or a running average of many intervals, (iii) number of postings from unique posters or visitors in a given interval, either as a total or with a running average, (iv) the number of times individual threads, posts or forums are opened or viewed, and/or (v) number of new postings in one thread (or forum). Numerous other criteria may also be considered.

In one embodiment, one or more of the metrics are measured for a thread that relates to a specific story, article or content item. This enables, for example, a site operator to identify a news story that is deemed to generate the most interest in a day.

In another embodiment, the one or more metrics are measured for a forum (numerous threads). But what is identified from for prominence is a thread in the forum, such as the most popular thread or the thread that ties to a specific article or news story.

One or more embodiments also take into account postings that may contain spam, solicitation, or otherwise marked for deletion by a moderator (such as for being off-topic). For example, any of the aforementioned metrics may be determined for a portion of a thread or forum that has been analyzed for spam, or reviewed by a moderator.

Step 130 provides that “hot threads” or “hot forums” are identified. The hot thread/forum may correspond to a thread or forum in which the level of user-activity meets a designated or pre-defined criteria. The criteria may quantify one or more of the metrics. For example, threads or forums having the greatest increase in activity over a previous interval (e.g. previous day) may be identified, or those threads or forums may be identified with the greatest amount of activity and which also exceed a minimum amount of activity. In addition to quantifying metrics, one or more embodiments may provide for other criteria to select or de-select a thread or forum for consideration. Such other criteria may include, for example, whether the postings or threads of a particular forum pertain or follow a news story, whether there is commercial solicitation (i.e. “spam”) or a high number of offensive posts, and the number of posters that are providing the increased number of posts.

Step 140 provides for some form of prominence to be provided to either the “hot threads” or (forums), or the pages on which “hot threads” are provided. The prominence may include re-display of links and/or content from the forums on one or more pages or locations of the site, including for example, the main page or location of the site.

Steps 142 to Steps 152 provide alternative or additional variation details for performance of step 140, according to one or more embodiments of the invention. In step 142, the hot threads are provided prominence by having links to those threads provided on the home or main page of the site. A label or other text may accompany the link to indicate, for example, the category or topic of the thread, as well as to indicate that the links display threads where there is significant user-interest. For example, links to hot threads may be provided under a heading of “What people are talking about today”. As mentioned, individual threads may be displayed with, for example, an associated news story or a link to that news story.

As an alternative or addition, step 144 provides that one or more pages or locations of the site (e.g. the main page) may be provided with a listing of hot threads, by name or by topic or category of what the threads pertain to. Step 146 provides that instead of linking to the thread when prominence is provided, the link connects to the forum, topic, category or other page on which the thread is provided.

Still further, step 148 provides the addition of placing or identifying for prominence categories or topics that contain hot threads or forums. For example, under a heading of “What is Hot Today”, the category or topic on which content items are aggregated and provided may be displayed, either in active link form or as inactive information. In the example, the identifier “Anna Nicole Smith” may be listed or linked, based on the determination that the page or location for content aggregation of “Anna Nicole Smith” is of interest in the given day or interval.

Step 150 provides, as an alternative or variation, that an icon or other representation indicating “hot” or high-interest is displayed without further information. The user may be invited to select the icon simply because it connotes information that its selection will direct the user to a thread, or news story associated with the thread, that at that moment or interval is deemed of significant interest.

Step 152 provides another variation or example to the display of prominence. In the case where postings are tied or appended to content items such as news stories, the actual news stories that generate the content may be represented in prominence. For example, text (e.g. summary, title, headline or picture) from the content item may be displayed in prominence (e.g. on a home page) with active links that enable the viewer to see both the story and the comments.

System Description

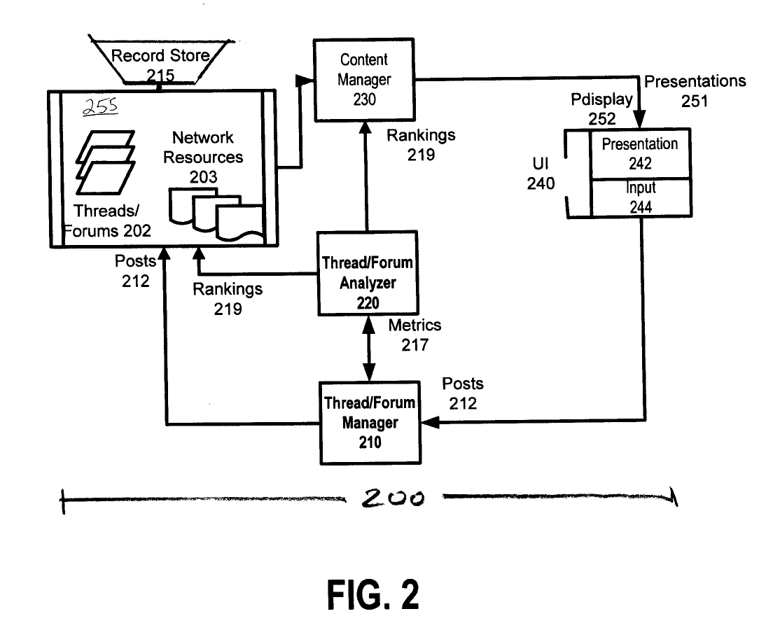

FIG. 2 illustrates a system for enabling prominence display of threads or forums on an online site, according to an embodiment of the invention. The prominence display may be made through a determination that includes ranking threads and/or forums on a variety of metrics. A system such as described with an embodiment of FIG. 2 may implement a method such as described with FIG. 1.

In an embodiment, a system 200 includes a forum/thread manager 210, record store 215, a forum/thread analyzer 220, and a content manager 230. The system may include a back end system 255 that locates content items and aggregates the content items for the site. The back end system 255 may store network resources 203 that correspond to links to content items, text or summaries of content items, pictures, or the actual content items or content therefrom. The network resources 203 may be stored as pages, or data items that can assembled into one or more pages. In one embodiment, the content items are provided specific topic, category or page assignments. Data identifying these assignments may be stored relationally with the content items, so that pages may be assembled or displayed by category or topic or other assignment.

The user-interface module 240 may provide a presentation component 242 (e.g. webpage or media presentation) and also provide an input mechanism 244 by which a user may create and/or submit text, links, images, or media for use in a post. The input mechanism 244 may provide an input field by which the user may enter text, select files, or make media recordings. In an embodiment, the forum/thread manager 210 receives a post from 212 from the user's interaction with the input mechanism 244 provided on the user interface 240. The interaction of the user may be in the form of text input or file attachment.

In one or more variations, posts may be submitted through messaging applications or transports, rather than interaction with the input mechanism 244. For example, a user may email or otherwise message a post with content included in the body or as an attachment to the message.

The forum/thread manager 210 may receive the posts 212 and perform a variety of functions related to displaying or rendering posts in forums. These include determining the thread or forum that the post is associated with, and editing or filtering posts that contain inappropriate content or otherwise.

According to one or more embodiments, forum/thread manager 210 may (i) discard the post 212 (i.e. the post does not get inserted on the forum), (ii) modify the post 212 (e.g. remove the inappropriate content), or (iii) sort and/or place the post 212 in a thread and/or forum 202 specified by actions or input of the user (e.g. user may open post for a particular forum). The posts 212 may be stored as records in the record store 215 for subsequent retrieval and display as part of web pages, accessible to individual browsers that access the site. When posts 212 are stored in the record store 215, they may be associated with metadata that identifies the forum, the thread, and the page or resource 203 that the forum or thread 202 is to be assigned or otherwise displayed in connection with. For example, forums or threads 202 may be associated with topics or categories (categories or pages).

The forum/thread analyzer 220 is an example of a user-generated content medium manager. The forum/thread analyzer 220 interacts with the data store 215 and/or the forum/thread manager 210 in order to identify or determine metrics 217 about individual forums or threads 202 that contains the post. As described with one or more embodiments of FIG. 1, the metrics 217 may correspond to measurements of a particular duration, including of the volume of posts 212 contained in an individual forum or thread, the increase in volume for the same, the number or occurrence of a unique poster, and the number of different posters that are present. Other metrics 217 include discounting forums or threads that receive spam or offensive posts (even when such posts are removed).

From the metrics 217, the forum/thread analyzer 220 may rank one or more forums. As an alternative or addition, forum/thread analyzer 220 may rank threads. The rankings 219 may identify a set of forums or threads that contain activity (as identified by metrics) that exceeds some designated threshold criteria. Alternatively, the rankings 219 may identify the “hottest” thread or forum, based on the metrics and priority provided to the metrics. In one implementation, for example, the forum or thread containing the largest change in newly added posts may be ranked first. The rankings may be limited to one (the “hottest”) or to many (“Top 10” or “Top 100”).

In another implementation, number of postings made to a given forum is evaluated (e.g. for greatest increase), with consideration and/or weighting provided to spam and inappropriate content removal, number of posters, and number of unique posters. Forums with greatest increase in activity are identified. From those forums 202, the individual threads that are of greatest activity (e.g. by volume) are identified as the “Hot Thread”. Certain criteria may be implemented in determining the “Hot Thread”, such as whether a given thread has an associated news story or other content item.

The forum/thread analyzer 220 may communicate the ranking 219 to the content manager 230 or store the ranking 219 with the record store 215. As an alternative to rankings 219 the forum thread analyzer 220 may simply identify which forum or thread is significant, or otherwise designated for prominence. The forum/thread analyzer 220 may continuously or repetitively scan new postings 212 or threads and update the rankings 219. Thus, for example, in the case where the online site provides current events and news, the rankings 219 may reflect headline stories or stories that are grabbing the most interest from people.

The content manager 230 may interact with the user-interface 240 in order to display pages or other presentations 251. In order to display pages, content manager 230 may retrieve network resources 203 from the record store 215 that are assigned to the particular page that is being displayed. The network resources 203 may be retrieved by category, topic or other heading, using metadata associated with individual network resources 203 that identifies the particular assignment. In addition to displaying network resources, pages or other presentations may be associated with threads or forums 202. The threads or forums 202 may be included or provided with network resources 203. The rankings 219 may be received from the forum/thread analyzer 220, or retrieved from the record store 215, and then used to identify the particular thread or forum 202 from which a prominence display 252 is to be generated.

The prominence display 252 may be provided on a particular page of the site, such as, for example the main page or home page. The act of making the prominence display 252 may also include selecting a location (e.g. the home page, or category page) for the prominence display 252. The prominence display 252 may correspond to result of operations such as described with sub-steps 142-152 of a method of FIG. 1. For example, in one embodiment, prominence display 252 corresponds to the content manager 230 directing the insertion of a link on the main page to one of the threads (or to a forum) that is deemed “hottest” in terms of user activity (as determined by the metrics 217 and by the rankings 219).

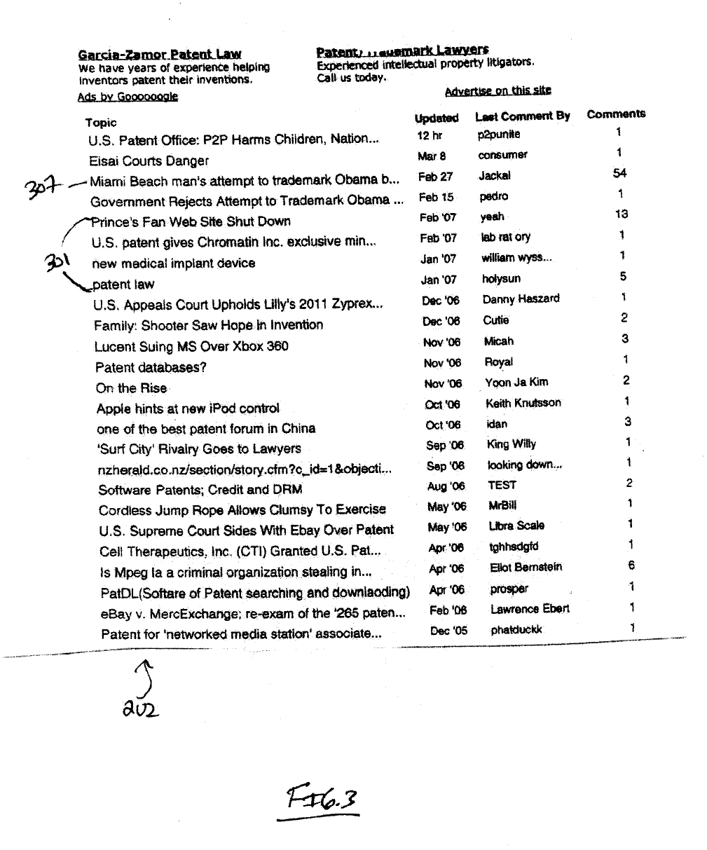

FIG. 3 illustrates one manner in which one of the forums 202 may be displayed, according to an embodiment. FIG. 3 displays a “Patent/Trademark Law Forum” with a list of threads 301, arranged by the order in which they were last updated. In an embodiment, the entire forum, or one of its threads 301, may be flagged as being of significant interest and displayed elsewhere in the site as “hot”. In order to determine the hot thread, the number of comments or messages 303 in a particular thread 301 may be determined. For example, the specific thread 307 contains the most comments at 54. This thread may be placed in prominence by being linked on a category page for the corresponding forum. When selected, the link may open the particular thread 307 from the category page without the user having to first open the thread 202. At the very bottom of the display is an input field for the user to insert a post or add a comment.

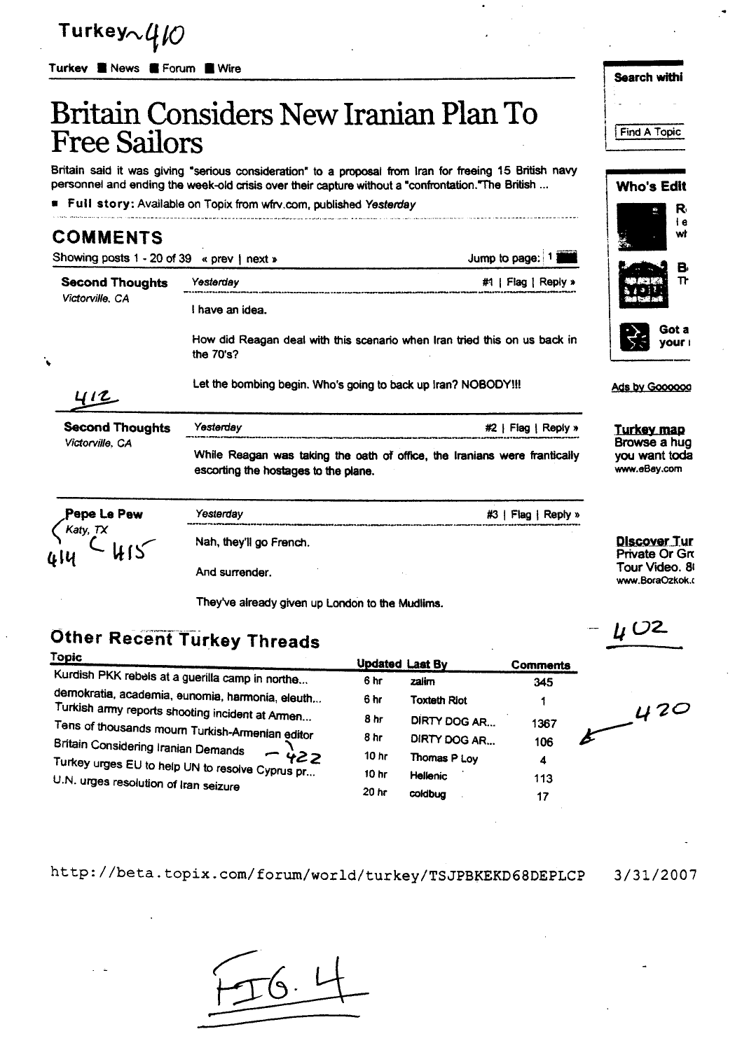

FIG. 4 is a screenshot of a thread 402, presented in connection with a news story 405 or other content item, under an embodiment of the invention. The association between the thread 402 and news story 405 may be based on both items being provided on the same page. The news story 405 may be provided as a link with, for example, summary text 406. Below the summary text 406, the thread 402 includes posts 412 from individual posters, who may be identified by moniker 414 and/or geographic location 415. The user's moniker or name 414 and location 415 may be displayed beside each post 412, and the date in which the post was created is also included at the top of each post. The page itself may be part of larger category 410 (“Turkey”). A forum 420 comprising other threads 422 may be listed on the same page 410. As described with one or more embodiments, the particular thread 402 may be deemed of significance because of some measurement of the activity with that threat. For example, the forum 420, associated with the category 410, may be deemed to have greatest increase in user-activity. From that determination, the thread 402 may be identified as being the most popular thread in the forum 420.

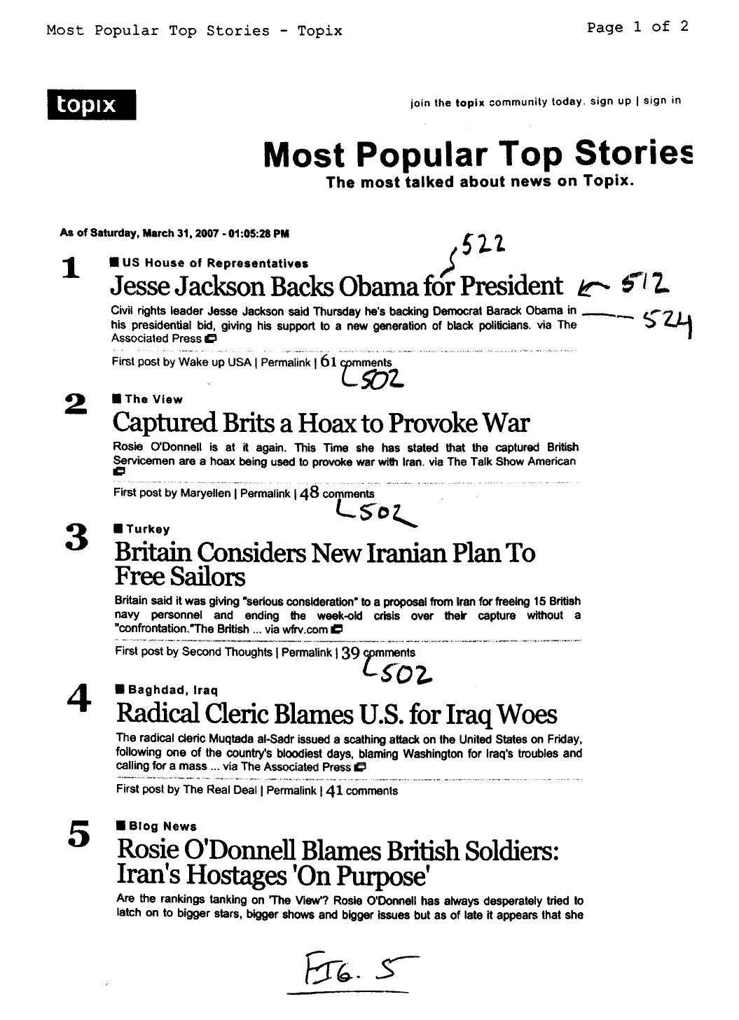

FIG. 5 illustrates one implementation for placing prominence to select threads or forums according to an embodiment of the invention. In FIG. 5, a main page may list “The Most Popular Stories”. Individual content items 512 may be displayed in the form of an active link headline 522, and a summary text 524. Below each content item, the link to the thread 502 for the content item 512 is provided. The selection of the content item 512 appearing on the page of prominence may be based on the number of posts added to the thread 502. In one embodiment, the identification of the thread 502 may be made in part by measuring the amount of activity for the forum associated with the category of the thread. An embodiment of FIG. 5 enables the Hot Forum or Thread to be displayed immediately from a quick link on one or the main pages (e.g. page of interest) provided on a site where content is aggregated. This promotes directing the audience to the Hot Link or Thread, in that the particular forum or thread in opened with one link from a main page, rather than requiring the user to navigate through category pages or other hierarchical arrangements to locate forums and threads. Moreover, the audience is informed as to which forums or threads have the most activity.

Conclusion

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A method for providing content on a website, the method comprising:
monitoring, during a given time period, an activity level of a plurality of user-generated content mediums;
selecting a set of user-generated content mediums from the plurality of user-generated content mediums for prominence, wherein selecting the set is based at least in part on the activity level of each user-generated content medium in the set; and
providing or identifying each of the user-generated content mediums in the set with prominence on the website.

2. The method of claim 1, wherein monitoring the activity level of the plurality of user-generated content mediums includes monitoring a number of postings made in each of a plurality of forums and/or threads that are hosted on the website.

3. The method of claim 1, wherein monitoring the activity level of the plurality of user-generated content mediums includes monitoring one or more of (i) a total number of postings to each of the plurality of user-generated content mediums that are monitored, or (ii) a change in the total number of postings to each of the plurality of user-generated content mediums from one time period to another.

4. The method of claim 1, wherein monitoring the activity level of the plurality of user-generated content mediums includes monitoring a number of postings made in each of the plurality of user-generated content mediums by new or occasional posters.

5. The method of claim 1, wherein providing or identifying each of the user-generated content mediums in the set with prominence is performed for at least a portion of the given time period.

6. The method of claim 1, wherein providing or identifying each of the user-generated content mediums in the set with prominence includes providing a link to one or more of the selected set of user-generated content mediums on a home page of the website.

7. The method of claim 1, wherein providing or identifying each of the user-generated content mediums in the set with prominence includes providing a link to one or more of the selected set of user-generated content mediums on a page that is different than a page on which the one or more of the selected set of user-generated content mediums is normally provided.

8. The method of claim 1, wherein providing or identifying each of the user-generated content mediums in the set with prominence includes listing one or more of the selected set of user-generated content mediums prominently on the home page of the website.

9. The method of claim 1, further comprising providing each of the plurality of user-generated content mediums in connection with an article about current events, and wherein the method further comprises displaying the article or information from the article in prominence at the website.

10. A method for providing content on a website, the method comprising:
providing a plurality of pages that comprise at least a portion of the website, wherein each of the plurality of pages is assigned to at least one corresponding topic and displays content based on a plurality of content items that have been programmatically and/or manually determined to be relevant to the at least one corresponding topic of that page;
on each of the plurality of pages, enabling one or more threads in connection with one or more of the plurality of content items;
monitoring, during a given time period, an activity level of at least some of the one or more threads at each of the plurality of pages; and
selecting a set of threads based at least in part on the activity level of each thread in the set.

11. The method of claim 10, wherein selecting a set of threads includes selecting the set of threads for prominence, and wherein the method further comprises displaying at least some of the threads in the set in prominence.

12. The method of claim 11, wherein displaying at least some of the threads in the set in prominence includes performing one or more of (i) displaying a portion of the at least one thread on a home page, or (ii) displaying a link to the at least one thread on the home page of the website.

13. The method of claim 12, wherein displaying at least some of the threads is performed during at least a portion of the given time period.

14. The method of claim 10, wherein the method further comprises providing the content item for each selected thread in the set in prominence on the website.

15. The method of claim 14, wherein providing the content item for each selected thread in the set in prominence includes displaying at least one of a link or a portion of the content item on a home page of the website.

16. The method of claim 10, wherein monitoring the activity level of at least some of the one or more threads includes monitoring a number of postings made in each of a plurality of threads that are hosted on the website.

17. The method of claim 10, wherein monitoring the activity level of at least some of the one or more threads includes monitoring one or more of (i) a total number of postings to each of the plurality of threads that are monitored, or (ii) a change in the total number of postings to each of the plurality of threads from one time period to another.

18. The method of claim 10, wherein monitoring the activity level of at least some of the one or more threads includes monitoring a number of postings made in each of the plurality of threads by new or occasional posters.

19. The method of claim 10, wherein the method further comprises identifying a category of a page on which one of the threads in the set of threads is provided, and displaying in prominence on the website at least one of (i) identification of the category, and/or (ii) a link to the page of the category.

20. A system for providing content on a website, the system comprising:
a content manager configured to generate data for a plurality of category-specific presentations, each category-specific presentation including content based on a plurality of content items that have been programmatically or manually determined to be pertinent to a category of that presentation;
a content medium manager configured to manage, for each category-specific presentation, one or more user-generated content mediums, each of the one or more user-generated content mediums receiving and displaying postings from users of the website;
an analyzer that monitors an activity level of each of the one or more user-generated content mediums on the website in order to select one or more user-generated content mediums for prominence; and
a presentation component that is configured (i) to receive the data from the content manger to provide the plurality of category-specific presentations, (ii) to communicate with the manager in enabling use and presentation of the one or more user-generated content mediums, (iii) to identify, from the analyzer, the selected one or more user-generated content mediums, and (iv) present the selected one or more user-generated content mediums in prominence on the website.

21. The system of claim 20, wherein the plurality of category-specific presentations each correspond to a web page that is assigned to one or more topics or categories.

22. The system of claim 21, wherein each web page displays articles and content for the one or more topics or categories that are assigned to that web page, and wherein at least some of the user-generated content-mediums each correspond to one of a forum for a category-specific page, or a thread for an article that is provided on that web page.
